(19) United States
(12) Patent Application Publication
(10) Pub. No.: US 2018/0026496 A1
(43) Pub. Date: Jan. 25, 2018

(54) MOTOR HAVING FUNCTION OF GENERATING AND FEEDING ELECTRIC POWER AT COIL END PORTION

(71) Applicant: FANUC CORPORATION, Yamanashi (JP)

(72) Inventor: Chao ZHI, Yamanashi (JP)

(21) Appl. No.: 15/623,379

(22) Filed: Jun. 15, 2017

(30) Foreign Application Priority Data
Jul. 19, 2016 (JP) 2016-141414

(51) Int. Cl. H02K 11/00; H02K 5/16; H02K 11/33; H02K 11/27; H02K 11/25

(52) U.S. Cl. CPC H02K 11/0094; H02K 11/27; H02K 11/25; H02K 11/33; H02K 5/16

(57) ABSTRACT

A motor according to an embodiment of the present invention has a stator including windings wound therein, and a rotor disposed inside the stator. The motor includes an electric circuit unit, and an induction generator coil disposed in the vicinity of a coil end of the winding so as to generate electric power by a change of magnetic flux generated by the winding. The electric circuit unit is driven by the electric power generated and fed by the induction generator coil.

This application is a new U.S. patent application that claims benefit of JP 2016-141414 filed on Jul. 19, 2016, the content of JP 2016-141414 is incorporated herein by reference.

### BACKGROUND OF THE INVENTION

### 1. Field of the Invention

The present invention relates to a motor, and specifically relates to a motor having an induction generator coil in the vicinity of a coil end of the motor so as to have the function of feeding the generated electric power to a sensor, an electrical circuit board, or an actuator disposed inside the motor.

### 2. Description of Related Art

The provision of sensors and actuators inside motors is required in accordance with increases in intelligence and functions of the motors. The numbers and types of the sensors and actuators are also increasing. The sensors and actuators require electric power. When the sensors and actuators are provided inside the motors, there is a need to provide conductive wires to feed electric power therethrough from the outside or an internal battery, in order to feed electric power to the sensors and actuators.

A technique in which electric power is generated in a generator coil using electromagnetic induction of a transmission coil is known (for example, Japanese Unexamined Patent Publication (Kokai) No. 2016-63699). Conventional motors have not taken advantage of varying magnetic fields at coil end portions of windings during operation.

### SUMMARY OF THE INVENTION

When electric power is fed through external conductive wires, an increased number of feeder lines complicate structure. When an internal battery drives a sensor, the battery requires man-hours to perform replacement, maintenance, and the like.

Furthermore, routing conductive wires from the outside into a motor, in which the numbers and locations of sensors and actuators are limited, may reduce water resistance of the motor.

A motor according to an embodiment of the present invention has a stator including windings wound therein, and a rotor disposed inside the stator. The motor includes an electric circuit unit, and an induction generator coil disposed in the vicinity of a coil end of the winding so as to generate electric power by a change of magnetic flux generated by the winding. The electric circuit unit is driven by the electric power generated and fed by the induction generator coil.

### BRIEF DESCRIPTION OF THE DRAWINGS

The objects, features, and advantages of the present invention will become more apparent from the following detailed description of the embodiments, along with the accompanying drawings. In the accompanying drawings:

FIG. 1 is a configuration diagram of a motor according to a first embodiment of the present invention;

FIG. 2 is a configuration diagram of a motor according to a second embodiment of the present invention; and

FIG. 3 is a configuration diagram of a motor according to a third embodiment of the present invention.

### DETAILED DESCRIPTION OF THE INVENTION

A motor according to the present invention will be described below with reference to the drawings.

### First Embodiment

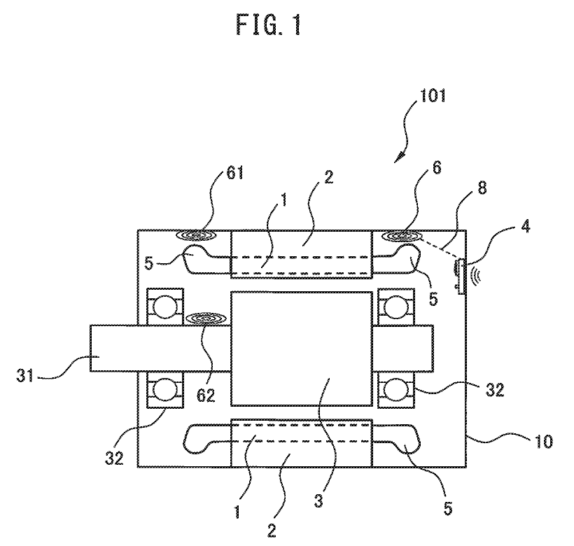

A motor according to a first embodiment of the present invention will be described. FIG. 1 is a configuration diagram of the motor according to the first embodiment of the present invention. A motor 101 according to the first embodiment of the present invention has a stator 2 including windings 1 wound therein, and a rotor 3 disposed inside the stator 2. The motor 101 includes an electric circuit unit 4 and an induction generator coil 6. The windings 1, the stator 2, the rotor 3, a bearing 32, the electric circuit unit 4, and the induction generator coil 6 are provided at a casing 10 of the motor 101. FIG. 1 shows a sectional view of the motor 101, and the stator 2 is cylindrical in shape. The rotation of the rotor 3 rotates a shaft 31 supported by the bearing 32.

The induction generator coil 6 is disposed in the vicinity of a coil end 5 of the winding 1 so as to generate electric power by a change of magnetic flux generated by the winding 1. “The vicinity of the coil end 5” denotes a range in which a change of magnetic flux generated by the coil end appears.

When the induction generator coil 6 is disposed at one of the coil ends 5 of the winding 1, a second induction generator coil 61 may be disposed at the other coil end. Moreover, a third induction generator coil 62 may be disposed in the vicinity of the shaft 31 of the rotor 3. Thus, one or more induction generator coils are provided.

The electric circuit unit 4 is driven by electric power generated and fed by the induction generator coil 6. The electric circuit unit 4 is electrically connected to the induction generator coil 6 through a feeder line 8. The electric circuit unit 4 preferably has a charging function.

The electric circuit unit 4 may be a current sensor to detect a current flowing through the winding 1.

The electric circuit unit 4 may be a temperature sensor or a vibration sensor to detect the temperature or vibration of the stator 2. As the temperature sensor for the stator 2, a thermocouple or the like can be used. As the vibration sensor for the stator 2, a piezoelectric acceleration sensor that detects a peak value of an acceleration component of vibration or the like can be used.

The electric circuit unit 4 may be a temperature sensor or a vibration sensor to detect the temperature or vibration of the rotor 3. As the temperature sensor for the rotor 3, a thermocouple or the like can be used. As the vibration sensor for the rotor 3, a piezoelectric acceleration sensor that detects a peak value of an acceleration component of vibration or the like can be used.

The electric circuit unit 4 may be a humidity sensor to detect the humidity inside the motor 101.

The electric circuit unit 4 may be a temperature sensor or a vibration sensor to detect the temperature or vibration of the bearing 32 for supporting the rotor 3.

The electric circuit unit 4 may be a magnetic sensor to detect the magnetic flux intensity inside the motor 101. As the magnetic sensor, a Hall element, a magnetic resistance element, or the like in which voltage or electric resistance varies in accordance with magnetic field strength and magnetic field direction can be used.

Accordingly, as described above, the electric circuit unit 4 is preferably a sensor to detect at least one of the current of the winding 1, the temperature or vibration of the stator 2, the temperature or vibration of the rotor 3, the humidity inside the motor 101, the temperature or vibration of the bearing 32 for supporting the rotor 3, and the magnetic flux intensity inside the motor 101.

As described above, according to the motor of the first embodiment of the present invention, electric power generated by the induction generator coil is fed to the sensor provided inside the motor, thus eliminating the need for providing a conductive wire to feed electric power to the sensor from the outside of the motor.

Furthermore, according to the motor of the first embodiment of the present invention, the internal power supply allows placement of the sensor even in a location in which the sensor is conventionally difficult to place. For example, when the induction generator coil is disposed in the vicinity of the rotor of the motor, the temperature sensor or the vibration sensor can be disposed in the vicinity of the rotor of the motor. It is possible to eliminate the need for providing a conductive wire or a signal line from the outside, thus allowing improvement in water resistance of the motor.

### Second Embodiment

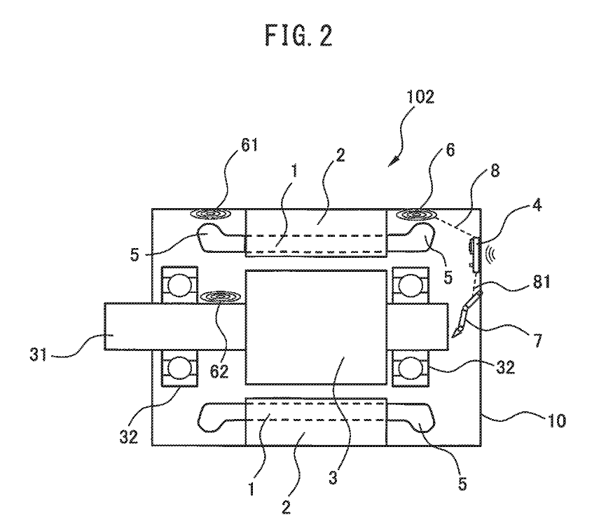

Next, a motor according to a second embodiment of the present invention will be described. FIG. 2 is a configuration diagram of the motor according to the second embodiment of the present invention. The difference between a motor 102 according to the second embodiment of the present invention and the motor 101 according to the first embodiment is that the electric circuit unit 4 drives at least one of an actuator 7 to remove foreign matter from the inside of the motor 102 or foreign matter from a cooling fan (not shown), an actuator to grease the bearing 32 for supporting the rotor 3, and a mechanism to apply a brake torque to the rotor 3. The other structures of the motor according to the second embodiment of the present invention are the same as that of the motor according to the first embodiment, so a detailed description thereof will be omitted.

The actuator 7 is operated by electric power fed by the electric circuit unit 4 through a second feeder line 81. The actuator (not shown) to grease the bearing 32 for supporting the rotor 3 and the mechanism (not shown) to apply a brake torque to the rotor 3 are also operated by electric power fed by the electric circuit unit 4 through feeder lines (not shown).

As described above, according to the motor of the second embodiment of the present invention, since electric power generated by the induction generator coil is fed to the actuators and brake mechanism disposed inside the motor, it is possible to omit conductive wires to feed electric power from the outside of the motor to the actuators and brake mechanism.

### Third Embodiment

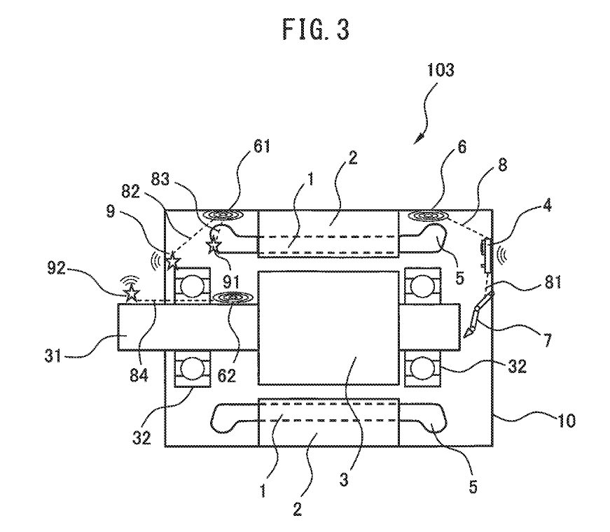

Next, a motor according to a third embodiment of the present invention will be described. FIG. 3 is a configuration diagram of the motor according to the third embodiment of the present invention. The difference between a motor 103 according to the third embodiment of the present invention and the motor 101 according to the first embodiment is that the electric circuit unit 4 has a wireless transceiver function. The other structures of the motor according to the third embodiment of the present invention are the same as that of the motor according to the first embodiment, so a detailed description thereof will be omitted.

As an example of the electric circuit unit 4 having the wireless transceiver function, there is a wireless sensor. Taking the electric circuit unit 4 that receives a measurement command from the outside at its wireless reception sensor as an example, a wireless sensor 9 is used as a sensor to detect the temperature or vibration of the bearing 32. The wireless sensor 9 is operated by electric power fed by the second induction generator coil 61 through a third feeder line 82. The detection data related to the temperature or vibration of the bearing 32 detected by the wireless sensor 9 is wirelessly transmitted to the outside.

A second wireless sensor 91 may be disposed in the vicinity of the coil end 5 to detect the temperature or vibration of the winding 1. The second wireless sensor 91 is operated by electric power fed by the second induction generator coil 61 through a fourth feeder line 83. The detection data related to the temperature or vibration of the winding 1 detected by the second wireless sensor 91 is wirelessly transmitted to the outside.

Furthermore, a third wireless sensor 92 may be disposed in the vicinity of the shaft 31 of the rotor 3 to detect the temperature or vibration of the rotor 3. The third wireless sensor 92 is operated by electric power fed by a third induction generator coil 62 through a fifth feeder line 84. The detection data related to the temperature or vibration of the rotor 3 detected by the third wireless sensor 92 is wirelessly transmitted to the outside. Upon detecting an excessive temperature or vibration, the third wireless sensor 92 transmits the detection or makes a notification about the detection to the outside in real time.

As described above, according to the motor of the third embodiment of the present invention, the use of wireless sensors allows omission of signal lines for sensors. The motor according to the third embodiment of the present invention contributes to increases in intelligence, functions, and reliability of the motor.

According to the motors of the embodiments of the present invention, since electric power generated by a magnetic field generated at the coil end can be fed to the sensors and actuators inside the motor, it is possible to eliminate the need for providing conductive wires from the outside of the motor to the sensors and actuators.

What is claimed is:

1. A motor having a stator including a winding wound therein and a rotor disposed inside the stator, the motor comprising:
an electric circuit unit; and
an induction generator coil disposed in the vicinity of a coil end of the winding so as to generate electric power by a change of magnetic flux generated by the winding,
wherein the electric circuit unit is driven by the electric power generated and fed by the induction generator coil.

2. The motor according to claim 1, wherein the electric circuit unit is a sensor for measuring at least one of a current flowing through the winding, the temperature or vibration of the stator, the temperature or vibration of the rotor, the humidity inside the motor, the temperature or vibration of a bearing for supporting the rotor, and the magnetic flux intensity inside the motor.

3. The motor according to claim 1, wherein the electric circuit unit drives at least one of an actuator to remove foreign matter from the inside of the motor, an actuator to grease a bearing for supporting the rotor, and a mechanism to apply a brake torque to the rotor.

4. The motor according to claim 1, wherein the electric circuit unit has a wireless transceiver function.
